(19) United States
(12) Patent Application Publication
(10) Pub. No.: US 2005/0035624 A1
(43) Pub. Date: Feb. 17, 2005

(54) Motor vehicle body with folding top

(76) Inventor: Friedrich Krohle, Saulheim (DE)

Correspondence Address: LAURA C. HARGITT;General Motors Corporation, Legal Staff, Mail Code 482-C23-B21, P.O. Box 300, Detroit, MI, 48265-3000, US

(21) Appl. No.: 10/875,067

(22) Filed: Jun. 23, 2004

(30) Foreign Application Priority Data
Jul. 14, 2003 (DE) 10331848.8

(51) Int. Cl. B60J 7/14

(52) U.S. Cl. 296/107.07

(57) ABSTRACT

In a motor vehicle body with a lower body part (1, 2, 3, 4, 5) and a folding top (10, 11) enclosing a passenger compartment (12) the roof includes a rear window part (11) and a roof part (10). In the top-up state the roof part (10) bridges an intermediate space between the rear window part (11) and a windshield part (9) attached to the lower body part. In the stowed state of the roof the rear window part (11) is placed over the roof part (10).

### TECHNICAL FIELD

The present invention pertains to a motor vehicle body with a folding top.

Such a car body with a folding top constructed essentially of two stiff parts of large area is known, e.g., from U.S. Pat. No. 5,033,789. In this design the roof includes a rear window part and a roof part hinge-jointed to it which is connected to a windshield part attached to the body in the top-up state. In the lower part of the body behind the passenger compartment a tilt-up panel is arranged under which a storage space is provided for the top when it is folded down. The panel is tipped up only to open and close the top; otherwise it is closed and forms a part of the outer shell of the vehicle. The space required by the folded roof below the panel is subtracted from the vehicle's luggage space. In addition the panel covers the outer shell which would otherwise be available for a trunk hatch of the vehicle. Therefore only a small trunk hatch can be provided, and accordingly the luggage space under it is small or poorly accessible.

A similar design is described in DE 44 45 570 C1. Here the trunk hatch and the panel are joined together as a single part, i.e. it is the trunk hatch which swivels about a swivel axis in its rearward region in order to receive the folded parts of the roof in the storage space under it. Because the swivel axis is positioned on the trunk side the use of the storage space for hauling cargo is made very difficult even when the top is up.

A design principle diverging from the two mentioned above is discussed in EP 0 884 208 A1. This document discloses a folding roof structure with rear window part and roof part in which the rear window part is not tilted back around an axis at its base in the direction of the trunk cargo space of the vehicle but rather forward into the passenger compartment. The roof part during the folding-down process is moved obliquely back and down essentially parallel, and in the stowed state fits in a flush manner into an extension of the trunk hatch region of the body. In order to be able to lower the roof part to that extent the rear window part which is hinged at its base to the bottom part of the car body must be swiveled steeply downward. The region of the passenger compartment covered by the folded roof part is therefore also no longer available for other uses. In particular it is impossible to install rear seats in the vehicle permanently. If rear seats are present they would have to be removed before the top can be stowed.

The objective of the present invention is to devise a vehicle body with a folding top which has a simple structure and only slightly impairs the storage space available in vehicle when stowed.

This problem is solved by a vehicle body with the features of claim 1. Since the roof part lies under the rear window part when the top is stowed, there is no need to provide a strong steep lowering of the rear window part in order to provide space for the roof part.

Rather the rear window parts and the roof parts in the stowed state are both preferably essentially aligned horizontally.

If they cover a rear region of the passenger compartment in this state than the passenger compartment can still be used as storage space.

The roof part can be pulled under the rear window part especially simply if the window part is wider than the roof part.

An especially simple body design is obtained if the roof part lies freely in the folded state, therefore remains part of the outer shell of the body when stowed.

In order to make a storage space below the folded window part and roof part large without unnecessarily interfering with the air resistance of the vehicle it is preferred that the roof part and the rear window part in the folded state come to lie at the level of the upper edge of the lower part of the body.

Any rear seats contained in the passenger compartment can remain in place when the roof is stowed; they are covered by the rear window part and the roof part in the folded state. The storage space available in this case is the volume between the seat areas of the rear seats and the lowest lying parts of the rear window and the roof.

The roof part is preferably held by two pairs—one pair on each side of the vehicle—of tilting supporting beams. These supports together with the regions of the roof part and the bottom part of the car body that they engage form a four-part hinge joint which determines the path of movement of the roof part between the open and stowed state of the roof in a simple way. These pairs of supporting beams, when the roof is up, are preferably arranged at the site of a B column and correspond to such a column in their function.

In order to reinforce the roof region of the car body, especially to improve the shape stability of the passenger compartment in the case of an accidental rollover, on the opposite sides of the car body supporting beams are arranged in each case in pairs connected by cross brackets. These cross brackets are preferably formed as one part with the supporting beams.

### DESCRIPTION OF THE PREFERRED EMBODIMENT

Other features and advantages of the invention can be derived from the description below of an example of embodiment with reference to the attached figures, which show:

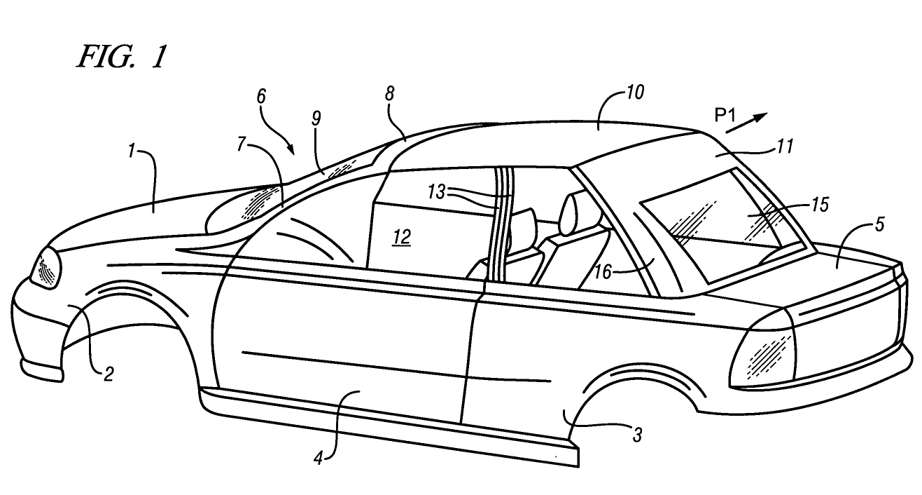

FIG. 1: a schematic perspective view of a vehicle body according to the invention with the top up,

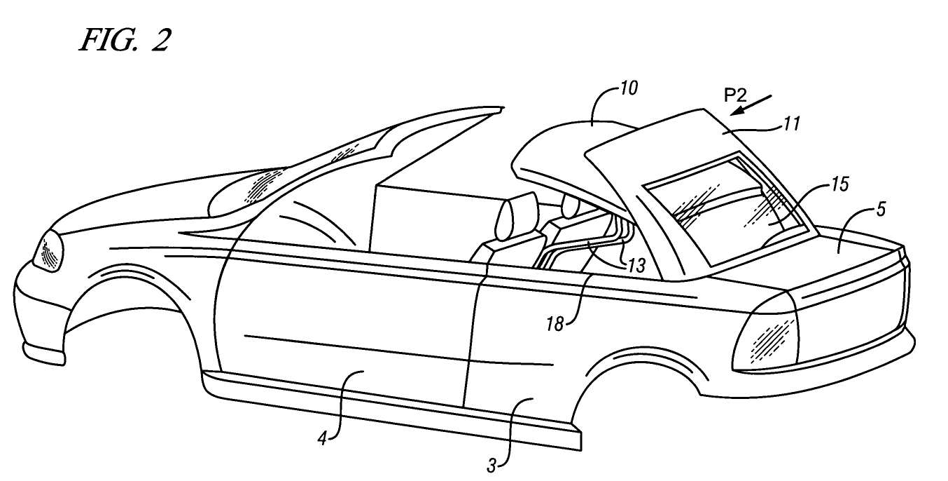

FIG. 2: the same car body with the roof partially folded,

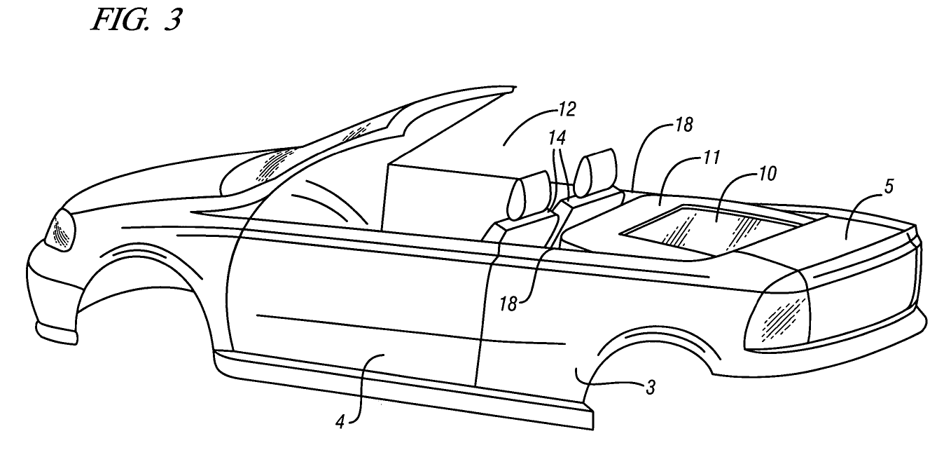

FIG. 3: the car body with the roof completely stowed,

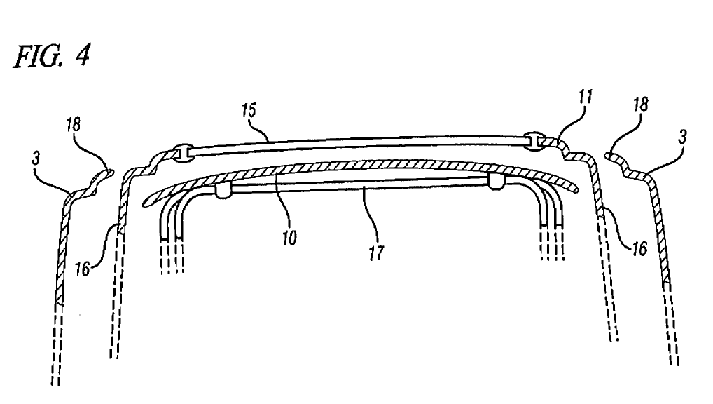

FIG. 4: a vertical partial section through the car body transversely to the direction of travel with the top stowed, and

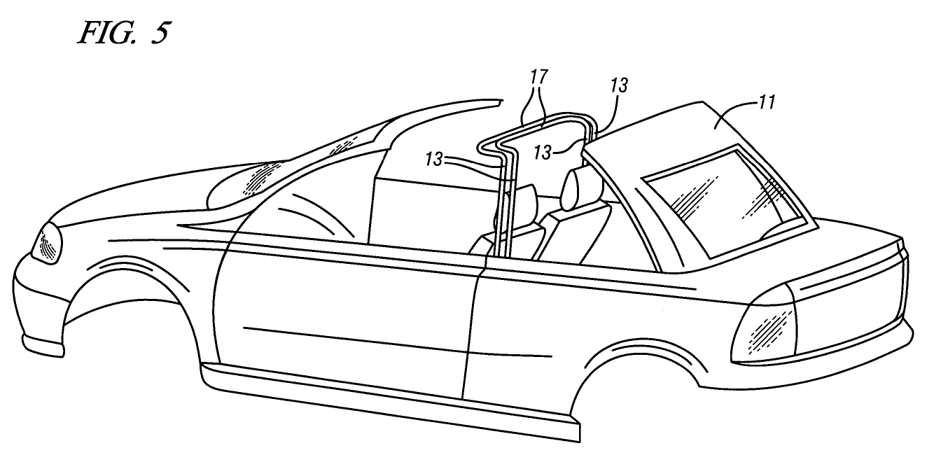

FIG. 5: the car body in the position of FIG. 1 but with the roof part omitted.

FIG. 1 is a perspective view of a motor vehicle body of hardtop design with a folding top according to the invention. The bottom part of the body with the hood 1, front and rear fenders 2, 3, door 4 and load space hatch 5 is conventional and need not be explained in detail. The upper part of the body includes the windshield part 6 with a windshield held between A columns 7 and a cross member 8, a windshield part 9, a stiff roof part 10 and a rear window part 11 extending above the passenger compartment 12. The roof part formed from a metal sheet 10 is detachably connected with its front edge to the cross member 8 and with its rear edge to the upper edge of the rear window part 11. Besides by connection to the adjacent body part the roof part 10 is supported on each side of the body by a pair of supporting beams 13 which are hinge-jointed to the roof part 10 and are capable of being tilted by a drive mechanism concealed in the rear fender 3.

The rear window part 11 is capable of swiveling about an axis which lies on its base slightly below the level of the storage space hatch 5.

In order to fold the top, first the rear window part 11 is tipped slightly upward in the direction of the arrow P1 in order to release the connection between the upper edge of the rear window part 11 and the rear edge of the roof part 10.

The roof part 10 can now be folded away backward by swiveling the supporting beams 13. The length of the supporting beams 13 and the position of their hinge axes, on the one hand on the fender 3, on the other on the roof part 10, is selected in such a way that the roof part 10 moves as a result of the backward tilting of the supporting beams 13 first into a steep position slightly to the rear, as shown in FIG. 2, so that the rear edge of the roof part 10 can be concealed under the rear window part 11. When the swiveling support 13 has reached the end of its freedom of movement, the roof part 10 is in an approximately horizontal orientation slightly below the upper edge 18 of the door 4 and rear fender 3. Since the windows on the opposite side of the body are closer together in the upward direction, the width of the roof part 10 is slightly smaller than the distance between the upper edges of the rear fenders. Therefore there is no difficulty in lowering the roof part 10 in this orientation slightly below the level of the upper edge 18. Thus it covers, if present, a rear seat (not shown) in the passenger compartment 12. Between a seat cushion of the rear seat and the roof part 10 in this case a storage space will remain which can be used for small luggage. In order to install more luggage in the storage compartment the rear seat can be designed to be removable so that it can be removed before the roof is closed. Such a removal of the seat, however, is not necessary for the folding process.

When the roof part 10 has reached its stowed position the rear window part 11 is also folded down in the direction of the arrow P2 until ultimately—disregarding convexities present for aerodynamic reasons—it comes to lie flush with the storage space hatch 5 and the upper edge 18 of the rear fender 3 in the position shown in FIG. 3.

In order for the roof part 10 to be covered completely by the rear window part 11 when the roof is stowed, the roof must be the longer of the two parts. Its length is selected such that in the stowed state in FIG. 3 it closes the rear part of the passenger compartment 12 essentially completely but without impairing the adjustability of the front seat 14 in the forward/backward direction. Part of the roof part 10 in this position is visible through the flat-lying rear window 15.

Since the roof part 10 in the folded down state does not protrude backward past the swivel axis of the rear window part, the storage space under the luggage hatch 5 is completely unimpaired by the stowing of the roof.

Since the moving parts 10, 11 in the folded state are not concealed under their own lid but rather the rear window part 11 remains freely visible, a simple economically realizable structure of the folding top results.

FIG. 4 shows a vertical partial section through the car body with the top. One recognizes the rear window part 11 with the rear window 15 lying approximately flush with the upper edge 18 of the fender 3 and below it the roof part 10. Since the roof part 10 is somewhat narrower than the rear window part 11, it fits with minimal space requirements between the side flanks 16 of the rear window part 11 which, in the open state of the roof, as shown in FIG. 1, assume the function of C columns. Toward its upper edge where the rear window part 11 tapers to the width of the roof part 10 the pulled down flanks 16 become increasingly narrower so that there also no space problems arise, and the roof part 10 can be positioned practically parallel to the rear window 15.

To illustrate the supporting structures FIG. 5 shows once more the car body in the configuration of FIG. 1 but without the roof part 10. Here one recognizes that the supporting beams 13 are connected as one part in pairs to the opposite sides of the car body in each case by straight cross members 17, which extend transversely below the roof part 10 and are hinge jointed to it. This one-part joining of the supporting beams 13 to each other provides considerable stiffening or reinforcement of the roof construction which acts as a roll bar in the event of an accident.

1. Motor vehicle body with a lower body part (1, 2, 3, 4, 5) and a folding top (10, 11) enclosing a passenger compartment (12), in which the folding top includes a rear window part (11) and a roof part (10) which in a top-up state covers an intermediate space between the rear window part (11) and a windshield part (9) attached to the lower body part, characterized by the fact that in a stowed state of the folding top of the rear window part (11) is laid over the roof part (10).

2. Motor vehicle body as in claim 1, characterized by the fact that the rear window part (11) and the roof part (10) in the stowed state are aligned essentially horizontally.

3. Motor vehicle body as in claim 1 or 2, characterized by the fact that the rear window part (11) and the roof part (10) in the stowed state cover a storage compartment in a rear region of the passenger compartment (12).

4. Motor vehicle body as in one of the preceding claims, characterized by the fact that the rear window part (11) is wider than the roof part (10).

5. Motor vehicle body as in one of the preceding claims, characterized by the fact that the rear window part (11) lies freely in the stowed state.

6. Motor vehicle body as in one of the preceding claims, characterized by the fact that the rear window part (11) and the roof part (10) in the stowed state come to lie at the level of an upper edge (18) of the lower body part.

7. Motor vehicle body as in one of the preceding claims, characterized by the fact that the passenger compartment (12) contains rear seats, and that the rear seats are covered in the stowed state of the rear window part (11) and the roof part (10).

8. Motor vehicle body as in claims 3 and 7, characterized by the fact that the storage compartment is between the rear seats and the rear window part (11) and/or the roof part (10).

9. Motor vehicle body as in one of the preceding claims, characterized by the fact that the roof part (10) is held by two pairs of swiveling supporting beams (13).

10. Motor vehicle body as in claim 9, characterized by the fact that each pair of swiveling supporting beams (13) is arranged at the position of a B column.

11. Motor vehicle body as in claim 9 or 10, characterized by the fact that the supporting beams (13) arranged on opposite sides of the car body are connected by cross beams (17).

12. Motor vehicle body as in claim 11, characterized by the fact that the cross beams (17) are formed as a single part with the supporting beams (13) connecting them.
